(19) United States
(12) Patent Application Publication
(10) Pub. No.: US 2023/0293266 A1
(43) Pub. Date: Sep. 21, 2023

(54) ORTHODONTIC ALIGNING DEVICE AND METHODS OF MAKING AND USING SAME

(71) Applicant: Inventagon LLC, Northvale, NJ (US)

(72) Inventors: Jarl Jensen, Nyack, NY (US); Moshe Davidovitch, Tel-Aviv (IL); Robert Sanford, Ft. Myers, FL (US); Nearchos Panayi, Limassol (CY)

(73) Assignee: Inventagon LLC, Northvale, NJ (US)

(21) Appl. No.: 18/152,460

(22) Filed: Jan. 10, 2023

Related U.S. Application Data
(60) Provisional application No. 63/319,810, filed on Mar. 15, 2022.

(51) Int. Cl. A61C 7/08; A61C 7/00

(52) U.S. Cl. CPC A61C 7/08; A61C 7/006

(57) ABSTRACT

A system and method for enhancing the function of orthodontic aligners is disclosed. The system is comprised of a conventional plastic dental aligner and a plurality of small magnets. Said magnets being affixed by means of a composite to both individual teeth as well as the aligner in corresponding locations. An object of the system is to slowly move teeth into alignment by applying an additional force to teeth through a magnetic pull.

### CROSS-REFERENCE TO RELATED APPLICATIONS

This application claims priority from U.S. Provisional Application No. 63/319,810, filed Mar. 15, 2022, the subject matter of which is incorporated herein by reference in its entirety.

### FIELD OF THE DISCLOSURE

The present disclosure generally relates to orthodontics. More specifically, it relates to a system and method for enhancing the function of orthodontic aligners.

### BACKGROUND OF THE DISCLOSURE

It is believed that one of the first non-metal, removable devices for straightening teeth was first developed in 1945 by the American orthodontist Harold D. Kesling. The device was a removable, custom-designed appliance that looked and functioned similarly to a mouth guard. It was made of rubber and was used in conjunction with traditional braces and sped up the teeth movement. It was also considered the predecessor to aligners—also known as ‘one-piece plastic splints.’ By the mid-1960's researchers started to document the success aligners which by this time were now being used to make minor teeth corrections. By the 1980's plastic was replaced by silicon and these newer versions were known as ‘Elastomer Devices’ and could allow tooth movements of up to 3 mm over shorter periods of time. In 1993, American orthodontist, John Sheridan devised the ‘Essix retainer’ which is considered by many to be the first aligner system because it could be tweaked in order to induce varying tooth movement by inserting small pins. In 1997 two Stanford University students, Zia Chishti and Kelsey Worth, invented the ‘Invisalign’ and the concept involved a series of removable clear plastic aligners aimed at adults seeking discreet orthodontic treatment and is believed to be the first to use a series of computer-aided models taken from one single impression. While many orthodontists now offer aligners, what is needed is a way to further enhance the load capacity of such aligners.

### SUMMARY OF THE DISCLOSURE

In some examples, an aligner includes a body having a plurality of indentations for accepting teeth, and a pair of magnets, a first of the pair of magnets being coupled to the body of the aligner.

In some examples, a method of aligning a tooth includes providing an aligner including a body having a plurality of indentations for accepting teeth, and a pair of magnets, a first of the pair of magnets being coupleable to the body of the aligner, and exerting a force on a target tooth of the plurality of teeth via the pair of magnets.

### BRIEF DESCRIPTION OF THE FIGURES

The accompanying drawings, which are incorporated herein and form a part of the specification, illustrate some, but not the only or exclusive, examples of embodiments and/or features.

FIG. 1A illustrates certain directional references related to surfaces of the teeth.

FIG. 1B is a schematic perspective view of an aligner with magnets according to one embodiment of the present disclosure.

FIG. 2 is a schematic illustration of the aligner of FIG. 1A and a detailed view of the magnets.

FIG. 3 illustrates a series of steps in a method of aligning a tooth.

FIG. 4 is a flowchart showing a method of aligning teeth according to one embodiment.

FIGS. 5-8 are images of scans showing the progressive movement of teeth using one embodiment of the present disclosure.

Other aspects of the present disclosure shall be more readily understood when considered in conjunction with the accompanying drawings, and the following detailed description, neither of which should be considered limiting.

### DETAILED DESCRIPTION OF FIGURES

The device herein disclosed and described provides a solution to the shortcomings in the prior art through the disclosure of a system and method for enhancing the function of existing orthodontic aligners. An object of the disclosure is to enhance the loading ability of conventional aligners. The system may rely on small powerful magnets that when attracted to one another have the ability to move teeth.

Another object of the disclosure is to allow specific teeth to be moved further than other teeth that are being moved by the aligner at the same time. For example, an orthodontist may select an aligner that fits several back teeth and then affixes magnets on several front teeth to allow them to move at a different rate of speed than the rear teeth.

Another object of the disclosure is to allow aligner magnets to be used temporarily during a treatment. For example, an orthodontist may choose to have a patient wear an aligner without magnets for several months and then have the patient switch to magnetized aligners.

Another object of the disclosure is to provide a means to vary magnetic loads depending on which teeth require specific movements. For example, an orthodontist may choose to position weak magnets on the rear teeth that are not required to move much and place stronger magnets on front teeth to allow the load to be increased and move front teeth at a different rate.

It is briefly noted that upon a reading of this disclosure, those skilled in the art will recognize various means for carrying out these intended features of the disclosure. As such it is to be understood that other methods, applications and systems adapted to the task may be configured to carry out these features and are therefore considered to be within the scope and intent of the present disclosure, and are anticipated. With respect to the above description, before explaining at least one preferred embodiment of the herein disclosed disclosure in detail, it is to be understood that the disclosure is not limited in its application to the details of construction and to the arrangement of the components in the following description or illustrated in the drawings. The disclosure herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present disclosure. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present.

By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The objects features, and advantages of the present disclosure, as well as the advantages thereof over existing prior art, which will become apparent from the description to follow, are accomplished by the improvements described in this specification and hereinafter described in the following detailed description which fully discloses the disclosure, but should not be considered as placing limitations thereon.

The terms “substantially,” “generally,” “approximately,” and “about” are intended to mean that slight deviations from absolute are included within the scope of the term so modified. In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation. Conventional components of the disclosure are elements that are well-known in the prior art and will not be discussed in detail for this disclosure.

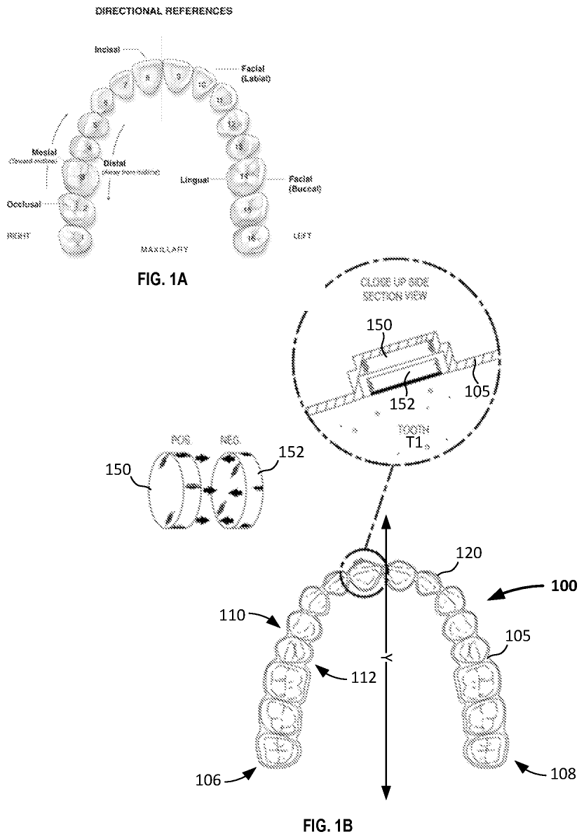

An adult human typically has 32 teeth including 8 incisors, 4 canines, 8 premolars and 12 molars (including 4 wisdom teeth). These are divided into 16 teeth in the upper jaw and 16 teeth in the lower jaw. Children typically have 20 baby teeth including 10 in the upper jaw and 10 in the lower jaw. These baby teeth act as placeholders for the adult teeth. FIG. 1A illustrates an example of a set of teeth and certain terms that may be used to describe the position and/or orientation of a tooth. Generally, distal refers to a surface or direction that is away from the midline of the face, while mesial refers to a surface or direction that is closer to the midline of the face. Facial refers to a surface or direction that faces the cheeks or lips, with labial referencing an element that is toward the lips, and buccal referencing an element that is toward the cheeks.

A common technique to straighten crooked teeth is through the use of an aligner system. An aligner system uses gentle, consistent pressures to move the teeth into predetermined positions along any of the directions described above. An aligner system will typically include a series of upper aligners and lower aligners, although “single-arch” options are also available for addressing issues like small gaps, or minor crowding. The present disclosure contemplates adding active engagement features to the upper aligners, the lower aligners or both. The process generally begins with a 3D scan of the teeth and jaws, and the manufacturing and use of successive aligners or trays to apply the necessary pressure. The overall required movement for a tooth is broken down into a series of “steps” corresponding to one or more of the aligners. At each step, the user may use an aligner to achieve the required movement, and then move on to a second to achieve additional movement.

FIG. 1B illustrates an aligner according to one embodiment of the present disclosure, although it will be understood that the disclosed techniques may be applied to one, multiple or all of the aligners in an aligner system having a series of steps including one or more upper aligners and/or one or more lower aligners. In this example, aligner 100 is an upper aligner, aligner 100 including an arch-shaped body 105 formed of suitable materials such as plastic or polymers (e.g., polyethylene terephthalate enhanced with glycol (BIOSTAR) polyethylene terephthalate (BenQ), thermoplastic polyurethanes, polyvinyl chloride, or other suitable biocompatible polymers), metals, alloys and/or other magnetic or magnetizable material(s). Aligner 100 generally includes a body 105 that extends from a first end 106 to a second end 108, and includes an outer or facial surface 110 facing the outside of the body, and an inner surface or lingual 112 facing the user's tongue. In this example, body 105 defines 16 indentations 120, each positioned, sized and shaped to receive a respective tooth of the user. Body 105 may be generally symmetric about a longitudinal axis Y, although it will be understood that variations are possible. In some examples, an aligner 100 may be formed with only two, four, six, eight, ten, twelve of fourteen indentations.

In some examples, aligner 100 includes at least one magnet to aid in aligning the teeth. In the variation shown, a pair of cylindrical-shaped magnets, 150,152 are used to cooperatively realign teeth. It will be understood that different shapes for the magnets 150,152 are possible, and that the two magnets may be of the same and/or different shapes. Additionally, the magnets 150,152 may be of the same, similar or different sizes. In the example shown, magnet 150 has a first polarity (e.g., positive) while magnet 152 has an opposite polarity (e.g., negative), such that the two magnets are attracted to one another. The polarities may be reversed. Additionally, it will be understood that variations are possible in which two magnets of a same polarity (e.g., both positive or both negative) may be used such that repelling of the two elements is used to aid in realigning teeth. In some examples, magnets 150,152 may include rare earth magnets, and may include but are not limited to: NdFeB, SmCo, AlNiCo, etc.

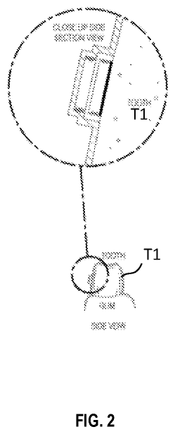

In FIGS. 1B-2, a first magnet 150 is coupled to an interior surface of aligner body 105, while a second magnet 152 is coupled to a tooth T1. In at least some examples, magnets 150,152 are affixed to portions of aligners (e.g., the inner surface 112 and/or outer surface 110) and/or to one or more corresponding teeth by means of composite adhesives such as but not limited to ceramics, epoxies and the like. For example, a first magnet 150 may be adhered to body 105 on an interior surface 112 adjacent a tooth T1, and a second magnet 152 may be adhered to tooth T1. In at least some examples, magnets may be coupled to an aligner via mechanical means (e.g., friction fit, clip-on, welding, etc.). Alternatively, an aligner may include a preformed pocket or void for receiving a magnet, and the magnet may be friction-fit or otherwise secured within the pocket or void with or without additional fixing means or adhesive. Once the two magnet 150,152 are in place, the user will wear the aligner and the magnets will interact with one another to provide an attractive (or repellant) force on a tooth as desired to provide active or continuous attachment or engagement between the tooth and the aligner and move the tooth from a first position to a second position over extended prolonged use. In some examples, the use of an aligner as described may be used to correct one or more of the following movement types: crown tipping, root tipping, torquing, rotation, translation, extrusion, intrusion, distalization, mesialization, expansion, proclination, and lingualization.

Based on the size, shape, material, location, and/or orientations of the magnets, the direction and magnitude of the force on a tooth may be chosen. In some examples, the magnets are selected with a strength to create micromovements (e.g., movement of less than ¼ mm at a time). That is to say, that in some examples, the magnets are not solely responsible for the movement of the teeth, but that they cooperate with the body of the aligner to provide such movement of a specific step. In at least some examples, the magnetic force between magnets 150,152 is equal to or less than the force of the aligner on the teeth. In some examples, the magnetic force is chosen so that it allows for micromovements but does not push the teeth beyond the boundaries of the aligner. The magnetic forces, whether attractive or repellant may vary between 15 grams and 50 grams of force depending on the position and orientation of the tooth, the desired intent of the adjustment and the expected time frame for making the adjustment. In some examples, the attractive or repellant forces may be between 50 grams and 150 grams of force. It will be understood that though a single pair of magnets 150,152 is shown in FIG. 1, an aligner 100 may include any number of magnets, or pairs of magnets, disposed at select positions. For example, a pair of magnets may be designated to each tooth on an aligner, or an aligner may have only one pair, two pairs, three pairs and so forth (e.g., 1-16 pairs) depending on the number of teeth to be adjusted via magnetic forces. Each pair of magnets designated to a tooth may have its own profile including a size, shape, material, location, and/or orientation for each of the pair of magnets that is different from or the same as another pair's profile. It is also possible to include two pairs of magnets on one tooth (e.g., a first pair on a buccal side and a second pair on the lingual side). By using these devices and techniques, a tooth may be moved with greater precision and control, that fewer aligners may be needed, or that the duration of each step in an aligner system may be shorter.

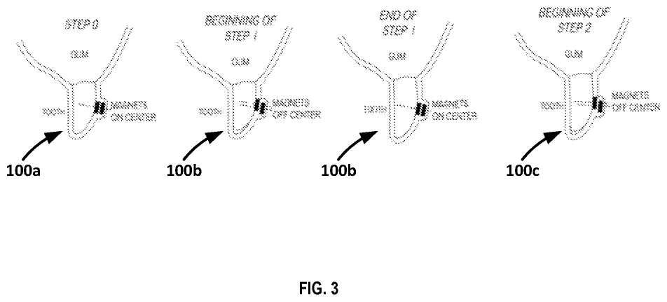

As previously noted, pairs of magnets may have different strengths. For example, a pair of front teeth magnets may have weaker load ratings than a pair of rear teeth magnet, or vice versa. Specifically, pairs of magnets with opposite polarity may allow for the attraction load to take place—thereby moving the teeth into alignment over time. FIG. 3 illustrates a series of steps whereby a misaligned tooth can be properly adjusted. In this example, a pair of magnets may be provided to urge a target tooth into position through a series of steps beginning with Step 0, continuing through Step 1 and Step 2, and so on. At Step 0, an aligner 100a may be used with two magnets, one coupled to the tooth and another to aligner 100a until the magnets are aligned through a micromovement of the tooth. At the beginning of Step 1, another aligner 100b may be used, the aligner being chosen to define a pair of magnets that are off-center as shown. Through the course of the use of aligner 100b throughout Step 1, micromovement of the tooth will continue until the magnets are aligned as shown at the end of Step 1. Once aligned, the user is now ready for the beginning of Step 2, where another aligner 100c may be used, again beginning with the magnets being off-center until they are aligned. This process may continue through a series of steps as necessary, each step defining its own micromovement trajectory of the tooth until the tooth ends up at the proper final position. It will be appreciated that each aligner 100a, 100b, 100c may be responsible for moving a single tooth or a plurality of teeth and that each aligner may include magnets disposed adjacent one or more of the teeth. At each stage, the two magnets of a pair may begin off-center and may gently come into alignment over time as they exert a force on the target tooth to engage it with the aligner and move it into place. It will be understood that the same pair of magnets may be used in different steps or that a different pair of magnets may be used in each step. In one example, one of the magnets (e.g., that on the tooth) may be constant throughout the staging, while the other magnet (e.g., that on the aligner) may be changed. The opposite is also possible with the aligner magnet remaining constant and the tooth magnet changing through the steps. Thus, the same or different magnets may be used in each of the steps. In some examples, the relative strength of the magnets at each stage may be different, and the strength of the magnets may progressively increase or decrease with each stage, depending on the desired outcome. Furthermore, it will be understood that the magnets may be misaligned at the point of transitioning to a next aligner while conferring a net benefit (e.g., a benefit is gained from the resulting forces regardless of whether alignment is perfect).

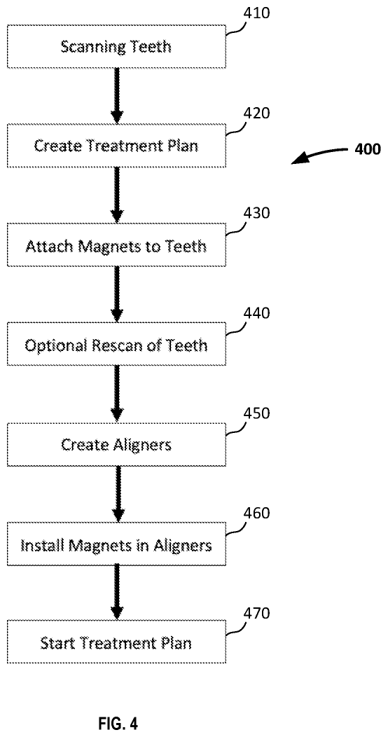

FIG. 4 illustrates a method of aligning teeth 400 that includes a series of steps terminating with using aligners as described above. First, method 400 may begin with scanning the user's teeth in step 410 and developing a three-dimensional model of a patient's mouth. This model may be in a common format and saved as an STL or STEP file, or the like. Next a treatment plan 420 may be created. In some examples, the treatment plan 420 includes creating a profile for each magnet that includes size, shape, material, location, and/or orientation for each of a pair of magnets. Additionally, magnets may be super-imposed over the three-dimensional model and load calculations may be performed based on general orthodontic alignment practices. Magnet selection may be based on loads required to move teeth according to orthodontist's recommendations. In at least some examples, the method may include simulating the movement of one or more teeth over time based on the magnet chosen. For example, a pair of magnets may be placed over a target tooth, and the method may simulate the outcome over a period of time (e.g., two weeks or two months). The physician may then decide that a stronger or weaker magnet would be more appropriate based on the simulation. After the appropriate magnets are identified and their relation to target teeth, magnets may be affixed to the teeth (step 430). Optionally, the teeth may be rescanned at this juncture (step 440) to ensure proper fitment. A series of aligners may be modeled and manufactured in step 450, and one or more magnets may be installed on the aligner in step 460. In some examples, magnets may be coupled to aligners and corresponding teeth by means of composite adhesives such as but not limited to ceramics, epoxies and the like. Alternatively, mechanical fixation means may be used as previously described. The treatment plan may then commence in step 470 as the user wears the aligner and magnets thereon interact and attract magnets affixed to the teeth and move teeth over extended, prolonged use. As previously noted, this process may be performed in stages or steps, and different magnets or magnets in different positions may be used as desired.

### Example 1

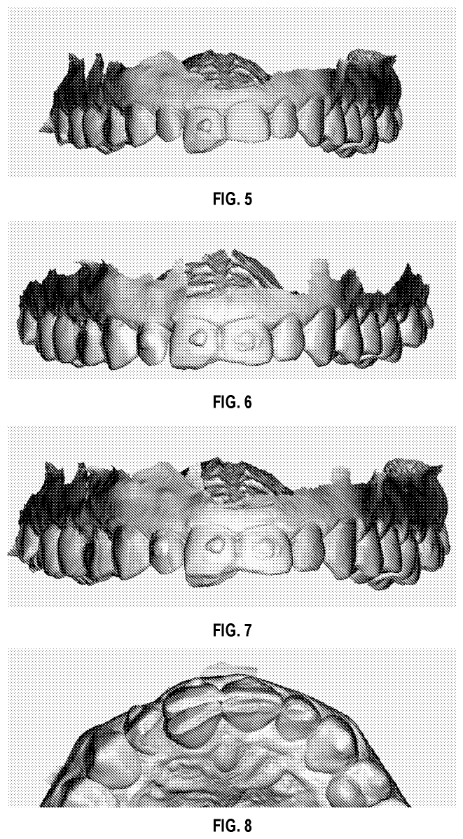

FIGS. 5-8 show scans of teeth movement of a patient in accordance with an embodiment of the present disclosure. In this example, a series of aligners in accordance with the present disclosure were used for proper intrusion and de-rotation. Specifically, a patient presented for orthodontic treatment requiring significant intrusion and de-rotation of maxillary anterior teeth and requested clear aligner therapy. Standard pre-treatment diagnostic records were made following clearance from a general practitioner. A 3D intraoral scan was taken as shown in FIG. 5 which shows a front view of a pre-treatment scan for the purposes of diagnosis and appliance design. It was determined that, in addition to general alignment, the maxillary right permanent central incisor required 4 mm of apically directed intrusion without any concomitant extrusion of the adjacent teeth.

A treatment plan to achieve these goals was created using Maestro3D Ortho Studio software to outline a series of steps using aligners in accordance with this disclosure. The treatment plan included implementation of an aligner system having gold-plated neodymium magnets (cylindrical discs of 2 mm diameter×0.5 mm height) bonded to the above-mentioned tooth, and onto the teeth to either side of it, and incorporated into each clear aligner of the steps in a juxtaposed position and in an attractive orientation. No other projections (i.e., composite attachments/buttons) were utilized. The result of the treatment plan are shown before and after 11 sequential steps of alignment.

Subsequent intraoral scans confirmed treatment progress of the correction of the position of the maxillary right central incisor. FIG. 6 is a front view of a mid-treatment scan after achievement of treatment objective on the maxillary right central incisor, and FIG. 7 is a front view of a composite having an overlaying of the scans of FIGS. 5 and 6. The effects of the aligners of the present disclosure on the position of the maxillary right central incisor can be seen. FIG. 8 is a similar occlusal view upper of a composite. Superimposition (overlaying) of these sequential scans with those of the predicted tooth position changes scheduled into the designed treatment plan show that the intended treatment objectives were achieved precisely and, notably, without mid-course corrections requiring additional aligners as evident in FIGS. 7 and 8.

At the time of this mid-course analysis, the patient's treatment is ongoing to complete the general alignment, but the major treatment objective of 4 mm intrusion of the maxillary right central incisor was achieved by the end of the 11^{th} sequential set of aligners. Without being bound to any particular theory, it is believed, based on extensive clinical experience that similar malocclusion treatment scenarios with other marketed aligner systems would expect to move teeth 0.25 mm per aligner which would require 16 aligners in a best-case scenario. Intruding teeth is not a best-case tooth movement scenario for other systems. Thus, intruding a tooth 4 mm with 11 aligners using magnets as described herein is a distinguished outcome. Additionally, the movement was accomplished with no mid-course correction or refinement, regardless of the number of aligners used.

The inability of clear aligners to dictate tooth movement with high predictability, control, and precision has been demonstrated to be a performance weakness of existing clear, sequential aligner products. The anatomical features of dental anatomy require that clear aligners be augmented with the inclusion of supplemental purchase points (attachments). Traditional composite attachments used in existing marketed products have not reliably reduced the gap in efficiency between clear aligner therapy and fixed appliances because the former depends on tooth movements mirroring those expressed in the plastic antimere. The replacement of “passive” composite attachments by “active” magnetic pairs provides a feature not currently expressed in any marketed sequential aligner system. In proof-of-concept clinical testing, the implementation of magnetic pairs appears to significantly improve the clinical efficiency of clear aligner treatment.

This example provides evidence that the correctly controlled implementation of magnets, such as neodymium magnets, instead of traditional, passive, composite attachments, to augment the mechanism of action of plastic sequential aligners appears to significantly increase the efficacy and efficiency of this treatment modality. There were no notable patient safety concerns encountered (as measured by occurrences of known and potential risks of the device as constructed and implemented).

It is additionally noted and anticipated that although the device is shown in its most simple form, various components and aspects of the device may be differently shaped or slightly modified when forming the disclosure herein. As such those skilled in the art will appreciate the descriptions and depictions set forth in this disclosure or merely meant to portray examples of preferred modes within the overall scope and intent of the disclosure, and are not to be considered limiting in any manner. While all of the fundamental characteristics and features of the disclosure have been shown and described herein, with reference to particular embodiments thereof, a latitude of modification, various changes and substitutions are intended in the foregoing disclosure and it will be apparent that in some instances, some features of the disclosure may be employed without a corresponding use of other features without departing from the scope of the disclosure as set forth. It should also be understood that various substitutions, modifications, and variations may be made by those skilled in the art without departing from the scope of the disclosure.

What is claimed is:

1. An aligner comprising:
a body having a plurality of indentations for accepting teeth; and
a pair of magnets, a first of the pair of magnets being coupled to the body of the aligner.

2. The aligner or claim 1, wherein the pair of magnets includes two magnets of a same polarity.

3. The aligner or claim 1, wherein the pair of magnets includes two magnets of opposite polarities.

4. The aligner or claim 1, wherein the pair of magnets includes two magnets of a same polarity.

5. The aligner or claim 1, wherein the second of the pair of magnets is coupled to a tooth.

6. The aligner or claim 1, wherein the first of the pair of magnets, and a second of the pair of magnets are capable of converging with one another.

7. The aligner or claim 1, wherein the first of the pair of magnets, and a second of the pair of magnets are disposed adjacent one another, and the pair of magnets are configured and arranged to be intentionally off-center at a beginning of a treatment step, and to be nearer to being centered by an end of the treatment step.

8. The aligner of claim 1, wherein the first of the pair of magnets is coupled to the body via a composite or an adhesive.

9. The aligner of claim 1, wherein the first of the pair of magnets are receivable within one or more pockets formed on the body.

10. The aligner of claim 1, wherein the load force between the pair of magnets is between 15 grams and 150 grams.

11. The aligner of claim 1, wherein the pair of magnets forms a first pair of magnets, and further comprising at least one additional second pair of magnets.

12. The aligner of claim 11, wherein the first pair of magnets is stronger than the least one additional second pair of magnets.

13. The aligner of claim 1, wherein the pair of magnets is configured and arranged to exert a first force on a tooth, the first force being smaller than a second force resulting from deformation of the body.

14. A method of aligning a tooth comprising:
providing an aligner including a body having a plurality of indentations for accepting teeth, and a pair of magnets, a first of the pair of magnets being coupleable to the body of the aligner; and
exerting a force on a target tooth of the plurality of teeth via the pair of magnets.

15. The method of claim 14, further comprising the step of coupling the first of the pair of magnets to the body of the aligner.

16. The method of claim 14, further comprising the step of coupling a second of the pair of magnets to the target tooth.

17. The method of claim 14, further comprising the steps of generating a model of a user's teeth, selecting an appropriate magnet for the target tooth, coupling a second of the pair of magnets to the target tooth, and placing the first of the pair of magnets opposite the second magnet to create a force on the target tooth.

18. The method of claim 17, wherein selecting an appropriate magnet comprises assigning load calculations to each of the pair of magnets based on the generated model.

19. The method of claim 17, wherein the model is a three-dimensional model.

20. The method of claim 17, wherein the pair of magnets includes magnets of a same polarity.
